(19) United States
(12) Patent Application Publication
(10) Pub. No.: US 2024/0041203 A1
(43) Pub. Date: Feb. 8, 2024

(54) MULTIFUNCTIONAL PIECE OF FURNITURE

(71) Applicant: CHALLENGEIT GMBH, Köln (DE)

(72) Inventor: Jan-Michael KONNERTH, Köln (DE)

(21) Appl. No.: 18/268,287

(22) PCT Filed: Dec. 1, 2021
(86) PCT No.: PCT/EP2021/083852

§ 371 Date: Jun. 19, 2023

(30) Foreign Application Priority Data
Dec. 18, 2020 (DE) 10 2020 134 244.6

(51) Int. Cl. A47B 77/06; A47B 77/08

(52) U.S. Cl. CPC A47B 77/06; A47B 77/08; B60P 3/38

(57) ABSTRACT

The invention relates to multifunctional piece of furniture (1, 20, 30), in particular for installing into a vehicle (40), for providing different functions which are used for different applications of a user, having a furniture body (2, 21) with an outer surface. The outer surface is divided into at least two different functional surfaces (11, 12, 13, 14) which are used for the different applications of the user. Each functional surface (11, 12, 13, 14) is paired with at least one specified use position, in which each functional surface (11, 12, 13, 14) can be used according to the application of the user, and at least one suspension means (6, 22) is provided which is designed and arranged so as to define a rotational axis (5) of the furniture body (2, 21) and keep the furniture body (2, 21) rotatable about the rotational axis (5) in a horizontal orientation at a furniture placement location (7) and at a distance to said location, wherein the respective use position of the different functional surfaces (11, 12, 13, 14) can be reached by rotating the furniture body (2, 21). The invention additionally relates to a method for using different functions of such a multifunctional piece of furniture (1, 20, 30), said functions being used for different applications of a user, to a vehicle (40) comprising such a multifunctional piece of furniture (1, 20, 30) which is functionally arranged in a vehicle interior (42), and to the use of such a multifunctional piece of furniture (1, 20, 30) in the interior (42) of a vehicle (40).

The invention relates to a multifunctional piece of furniture with a furniture body for providing various functions serving different intended uses of a user. The invention further relates to a method for using various functions of a multifunctional piece of furniture that serve different intended uses of a user. The invention also relates to a vehicle, in particular a habitable motor vehicle.

Multifunctional furniture that provides a user with several functions serving different intended uses is known per se.

For example, AT 521492 A4 describes a furniture system with a furniture unit that can be rotated about a horizontal axis of rotation and encloses an internal volume in which both a seating device and a lying device are arranged on diametrically opposite inner walls of the furniture unit. By turning the furniture unit, one of the two devices can be brought into a lower usage position, in which it can be used by a user. Disadvantages of the furniture system described are, inter alia, its voluminous and complex structure.

DE 10 2012 007 690 A1 also discloses a combination piece of furniture that provides a bed and table function. For this purpose, a lying board and a table top are arranged at right angles to one another between two side panels, so that either the table top or the lying board can be brought into a horizontal usage position for use by a user by tilting the combination furniture by 90°. The handling of the combination furniture, in particular with regard to changing its usage position, is found to be, inter alia, strenuous and time-consuming and is therefore relatively uncomfortable.

Against this background, the object of the invention is to create a multifunctional piece of furniture that provides several functions serving different intended uses in a particularly space-saving manner, so that maximum use can be made of a predefined converted space. The multifunctional furniture should accordingly have the smallest possible floor space and the smallest possible volume. At the same time, it should be possible to change between different usage positions, in which the various functions can be used by a user, conveniently, quickly and without great effort. Quite particularly, it should be possible for the user to carry out these changes without risk of injury. The invention is also based on the object of providing a method for using various functions of a multifunctional piece of furniture serving different intended uses for a user with the previously described advantages, and also a vehicle which at least also has such advantages.

This object is achieved by a multifunctional piece of furniture having the features of claim 1, by a method having the features of claim 18 and by a vehicle having the features of claim 28. Further, particularly advantageous embodiments of the invention are disclosed in the respective dependent claims.

It should be pointed out that the features listed individually in the claims can be combined with one another in any technically meaningful way (even across category boundaries, for example between method and device) and show further embodiments of the invention. The description additionally characterizes and specifies the invention, in particular in connection with the figures.

It should also be pointed out that an “and/or” used herein, standing between two features and linking them to one another, must always be interpreted in such a way that in a first embodiment of the subject matter according to the invention only the first feature can be present, in a second embodiment only the second feature can be present and in a third embodiment both the first and the second feature can be present.

In addition, the term “about” is used herein to indicate a tolerance range that is considered to be normal by the person skilled in the art working in the present field. In particular, the term “about” means a tolerance range of the related quantity of up to a maximum of +/−20%, preferably up to a maximum of +/−10%.

In the sense of the present invention, relative terms used hereinafter in relation to a feature such as “larger”, “smaller”, “wider”, “narrower”, “higher”, “lower”, “heavier”, “lighter” and the like should always be interpreted such that manufacturing-related size deviations of the relevant feature, which lie within the manufacturing tolerances defined for the respective manufacture of the relevant feature, are not covered by the respective relative term. In other words, according to this definition, a size of a feature should only be considered to be “larger”, “smaller”, “wider”, “narrower”, “higher”, “lower”, “heavier”, “lighter” and the like in the sense of the present invention than a size of a comparative feature if the two compared sizes differ so significantly in their value that this size difference certainly does not fall within the manufacturing-related tolerance range of the relevant feature but is the result of targeted action.

According to the invention, a multifunctional piece of furniture, in particular for placement in a (habitable) vehicle such as a motor home, camper van, caravan, camping van, transporter, bus, and the like, but without being necessarily limited to this, has a furniture body with an exterior surface to provide different functions serving various intended uses of a user. In general, the load-bearing parts of the multifunctional piece of furniture should be understood as furniture body so that its outer surface is substantially formed by the wall parts lying on the outside. The outer surface can be configured as a substantially closed surface but is not necessarily limited to this.

Furthermore, according to the invention, the outer surface of the furniture body is divided into at least two different functional surfaces serving different intended uses of the user, wherein each functional surface is assigned at least one predetermined usage position in which the respective functional surface can be used by the user as intended according to its intended use. Each functional surface therefore has its own usage position so that the envisaged use of the functional surface as intended can be carried out by the user. It should be understood that the positions of use of different functional surfaces can be different, but can also be the same in certain cases. It can be provided that, for example, when three or more different functional surfaces are provided, two functional surfaces can be used as intended by the user in one and the same usage position but without necessarily being limited to this.

Furthermore, at least one suspension means is provided according to the invention, which is configured and arranged to define an axis of rotation of the furniture body and keep the furniture body rotatable about the axis of rotation in a spatially horizontal orientation at a furniture placement location e.g. a vehicle interior of the vehicle already mentioned, at a distance from the furniture placement location, that is from the surfaces forming the furniture placement location, such as a floor surface, a wall surface, a ceiling surface and the like. Thus, the furniture body can be rotated freely about the defined axis of rotation, which is aligned horizontally in the space of the placement location, by means of the suspension means fundamentally at its placement location with respect to this. The different usage positions can thus correspond to different angular positions of the furniture body. A horizontal alignment in the sense of the invention is to be understood as a direction which runs substantially parallel to the earth's surface or substantially at right angles to the direction of the local gravitational acceleration. A vertical orientation of the axis of rotation at the placement location, i.e., one that follows the local gravitational acceleration, does not lead to the intended and functional use of the multifunctional furniture.

The multifunctional furniture according to the invention thus provides several functions serving different intended uses, preferably more than two, e.g. three or four or even more, in a space-saving manner whereby only one surface at the placement location, which must correspond to the base surface of the furniture body, and a spatial volume must be provided at the placement location that substantially corresponds to the volume of the multifunctional furniture plus a usage volume required by the user for the intended use of the multifunctional furniture. The rotatability of the furniture body at the placement location makes it possible to draw maximum benefit from a given converted space of the furniture placement location, in that the base area/room volume at the placement location can advantageously be used several times. In addition, the individual functional surfaces can be conveniently and safely be brought into their respective usage positions by the user in which they can be used by the user as intended without major expenditure of time and without great effort. Since the furniture body is always held securely at the placement location by the suspension means, the risk of injury to the user as a result of uncontrolled movement of the furniture body is almost completely ruled out, at least reduced to a maximum extent compared to a piece of furniture that has to be tipper over by the user on a floor surface, in order to make the various functional surfaces accessible.

The multifunctional piece of furniture according to the invention is therefore particularly suitable for use in habitable placement locations that are naturally characterized by relatively little available space, such as in motor homes, camper vans, caravans, camping vans, vans, coaches and the like, as well as in trains, boats, ships, aeroplanes or also at stationary placement locations such as holiday apartments, hotel rooms, apartments with only one or two rooms, etc.

The rotation of the furniture body about the axis of rotation, which is kept substantially spatially horizontally aligned at the placement location, can be carried out in the simplest manner by muscle power, whereby the user rotates the furniture body, for example with his hand. For this purpose, for example, a drive means can be provided in the form of a hand crank arranged on the axis of rotation.

Alternatively or additionally, the rotation of the furniture body can also be carried out with the aid of an electric motor which is provided.

For a uniform rotational movement of the furniture body, which is particularly advantageous in manual operation in terms of stress and ease of use, the (imaginary) axis of rotation defined by the at least one suspension means runs within the furniture body in such a manner that the torques brought about during a complete rotation of 360° of the furniture body with respect to the axis of rotation are minimized and compensated overall. The suspension means or means, taking into account the specific structure of the furniture body and the functional surfaces provided on its outer surface, which can be provided with different components, functional components, equipment and the like (i.e. different in number and weight) to provide the desired function, can be placed accordingly on the furniture body.

A particularly advantageous embodiment of the invention provides that the furniture body is configured substantially in the form of a prism, wherein the prism generally has a base surface, an opposite top surface and a lateral surface connecting the base surface to the top surface. The lateral surface of the prism here corresponds to the outer surface of the furniture body, which can substantially be considered to be closed. Correspondingly, the base surface and the opposite surface of the prism form the respective end faces of the furniture body.

In other words, the furniture body in the present embodiment is substantially configured as a geometric (prismatic) body that is formed by parallel displacement of a planar polygon describing the base surface along a straight line in space that does not lie in the base surface. The base surface and the top surface are congruent and parallel to each other. The distance between the base surface and the top surface (i.e., the end faces in the case of the present furniture body) is known to be designated as the height of the prism, wherein the term “length” of the furniture body is also used synonymously herein for the height of the prism. The furniture body, which is configured substantially in the manner of a prism, consequently has a highly symmetrical structure, which is particularly advantageous for a uniform rotatability of the furniture body about the axis of rotation with torques compensated over the full scope of rotation.

The length of the furniture body is preferably, for example, between 180 cm and 220 cm, but without being necessarily limited to this. Depending on the specific usage purpose, the length can also be less than 180 cm, wherein a minimum length is preferably at least 60 cm. The length of the furniture body can also be greater than 220 cm, for example, up to 300 cm. It has been shown, however, that a maximum length of about 220 cm to a maximum of about 240 cm is advantageous with regard to a uniformly achievable rotatability of the furniture body and is therefore particularly preferred, especially when the furniture body is rotated by muscle power.

In a further advantageous embodiment of the invention, the base surface and top surface of the prismatic furniture body are configured in the form of a polygon, each having three or four corners. Accordingly, the lateral or the outer surface of the furniture body naturally has at least three or four subdivided surfaces which are inclined towards one another and are therefore delimited from one another, which can serve as the various functional surfaces. The simple geometric structure of the furniture body according to the present embodiment enables, inter alia, an inexpensive production and a simple assembly.

According to another preferred development of the subject matter according to the invention, the base surface and the top surface of the prismatic furniture body are configured in the form of a polygon, each with six corners or eight corners. In other words, the number of corners of the polygon course of the present embodiment is doubled compared to the triangular or quadrangular polygon course described above. In the present case, however, the corners are not equidistantly spaced along the polygon course but the hexagonal and octagonal polygons each have three or four equal-length sides having a first length and three or four equal-length sides having a second length smaller than the first length. The first, longer length of the base surface and top surface polygon, together with the length of the furniture body, determines the usable area of the respective functional surface, with the result that the present embodiment of the furniture body also has a total of three functional surfaces. The second, shorter length of the base surface and top surface polygons substantially provides a bevelled transition from one functional surface to the next functional surface. Due to the bevel, the usable area of the functional surfaces is slightly reduced compared to a configuration with directly adjacent functional surfaces without a bevelled intermediate surface, but advantageously also the maximum radius or diameter to be taken into account for the rotation of the furniture body is reduced. The furniture body is more compact and requires an even smaller volume at the placement location. In addition, sharply tapering abutting edges on the furniture body are completely avoided according to this embodiment, which, in addition to an increase in comfort for the user, not least also enables a visually more attractive design of the furniture body.

According to a further advantageous embodiment of the invention, the suspension means has a through-opening in the direction of the axis of rotation, which is adapted for guiding at least one supply line for power, gas and/or water into the furniture body. In addition to fixing the axis of rotation and the rotatable mounting of the furniture body at the placement location, the suspension means also fulfils the function of supplying power, water or gas to the functional surfaces, for example in order to be able to operate electrical devices, and to be able to provide a washing function (water) and/or a heating function (gas). In order to ensure the rotatability of the furniture body, the suspension means can provide appropriate rotary couplings from or to the outside despite the stationary supply of the supply lines. These can be configured to introduce power, gas, water and the like safely or in a fluid-tight manner from the outside into or out of the furniture body (e.g. service water). It is conceivable to provide the supply of multiple supply lines via only a single rotary coupling by arranging the plurality of supply lines concentrically on the rotary coupling. For example, an internal fresh water supply line could be provided, which is concentrically surrounded radially further outwards by a service water drain line (or vice versa). Even further outwards, a power transmission can also be provided, for example, without however being necessarily limited to the aforesaid sequence or number.

An advantageous development of the subject matter of the invention provides that the suspension means is configured as shaft pieces provided on two opposite end faces of the furniture body or as a shaft running between the two opposite end faces of the furniture body. The shaft pieces or the shaft are to be understood as elongated, cylindrical machine elements that are also used to transmit rotational movements and torques. The axis of rotation of the furniture body is defined by the alignment of the cylinder axis of the shaft pieces or the shaft. The shaft pieces or the shaft can be formed from a solid material or be configured as hollow shafts. In any case, the rotational force required to rotate the furniture body can be introduced into the shaft from outside by muscle or motor power and transmitted via this to the furniture body, provided that this is non-rotatably connected to the shaft or the shaft pieces. In the case of a prismatic furniture body, the end faces correspond to the base and top surface of the prism, as has already been explained.

For the sake of simplicity, only the term “shaft” will be used in the following, wherein the term “shaft” is intended to include both the shaft pieces and the entire shaft extending between the two end faces, unless expressly stated otherwise.

Particularly preferably according to a further embodiment, the shaft (thus also at least one of the shaft pieces, preferably both) has a through-opening running in the direction of the axis of rotation, as has already been explained elsewhere herein in general for the example of the suspension means. In other words, the shaft in the present case is configured as a hollow shaft at least on the input and/or output side. Corresponding supply lines (e.g. power, gas, water, etc.) can be guided into the furniture body or out of this through the shaft cavity. Appropriate rotary couplings for safe and/or fluid-tight media passage can be provided in such a case in order to connect the stationary supply lines to the rotatable furniture body from the outside. It should be noted that the configuration of the shaft as a hollow shaft is not necessarily coupled to the passage of supply lines. The shaft can also advantageously be configured as a hollow shaft without connecting supply lines, for example, in order to reduce the weight of the multifunctional piece of furniture.

In general, it should be noted with regard to the rotary coupling that such a rotary coupling can be implemented, for example, for power transmission, for example via sliding contacts on the coupling parts to be rotated relative to one another. Alternatively, the rotatable power transmission can advantageously also be provided by way of an inductive energy transmission, which is particularly low-wear or wear-free and consequently maintenance-free due to the lack of contact of the coupling parts rotating relative to one another.

Several supply lines can also be routed via a single rotary coupling by arranging these concentrically on the rotary coupling. For example, an internal fresh water supply line could be provided, which is concentrically surrounded radially further outwards by a service water drain line. (or conversely). Further outwards, for example, a power transmission can also be provided by the rotary coupling, but without being necessarily limited to the aforesaid sequence or number.

For a rotary drive of the furniture body that can be implemented in a structurally simple manner, according to a further preferred embodiment, the furniture body is connected non-rotatably to the shaft pieces or the shaft. Accordingly, the shaft can be rotatably mounted at the furniture placement location, so that a rotation of the shaft brings about the rotational movement of the furniture body.

However, the invention is not limited to the previously described type of rotary drive. It is conceivable to provide, instead of the shaft, a rigid axle or axle pieces at the end, on which the furniture body is rotatably mounted. In this case, the axle itself is not used to transmit torques but only to hold the furniture body in a fixed position at the placement location at which the axle or axle pieces can then be firmly clamped (at least non-rotatably).

In a further development of the subject matter of the invention, at least one support is provided, which is configured and arranged to accommodate the suspension means in a rotatable or non-rotatable manner and to hold it in a fixed position at the furniture placement location and at the predetermined distance from it. The support which can be configured, for example, in the form of a trestle, leg and the like that can be adjusted or fastened on a floor surface of the placement location, can be a part of the suspension means and thus a component of the multifunctional furniture, but without being necessarily restricted to this. For example, the support can also be functionally provided by a part of the placement location, such as a wall or ceiling. In such a case, the multifunctional piece of furniture does not have such a support, since the spacing and support function is already completely provided by the furniture placement location.

Furthermore, in another embodiment of the invention, a fixing device can be provided which optionally enables or prevents the rotation of the furniture body. The furniture body can be fixed at least in the individual usage positions of the various functional surfaces by means of the fixing device in order to ensure safe use of the respective functional surfaces. The fixing can be accomplished, for example, by latching, clamping and the like or, in the case of a rotary drive provided by an electric motor, by the electric motor itself and/or a transmission possibly provided for the rotary drive (e.g. by self-locking).

According to an advantageous further development of the subject matter according to the invention, the fixing device always releases the rotation of the furniture body only in a predetermined direction of rotation. This is of particular advantage inter alia when supplying the furniture body with a liquid medium (e.g. water) since in this way the control over the necessarily flowing medium during the rotation of the furniture body can be improved. For example, service water located in a drain of a sink can be prevented in this to way from flowing out of the drain in an uncontrolled manner when the furniture body is rotated in the direction of rotation presently prevented by the fixing device.

According to a preferred embodiment of the invention, the respective intended use of the functional surfaces is selected from the group consisting of working, cooking, storing, sleeping, wherein the functional surface with the intended use “working” provides the user with at least one flat work surface (e.g. writing surface), the functional surface with the intended use “cooking” provides the user with at least one hotplate (e.g. electric or gas stove) for heating food, the functional surface with the intended use “storing” provides the user with at least one storage space for storing objects and the functional surface with the intended use “sleeping” provides the user with at least one lying surface.

According to a preferred further development of the subject matter of the invention, the storage space within the furniture body is formed by a tube running parallel to the axis of rotation which is held rotatably on the furniture body. Naturally that the tube and the furniture body have appropriate storage space openings in order to be able to insert the objects into the tube and remove them again. The rotatable mounting of the tube on the furniture body has the essential advantage that the position of the storage space tube does not change for the user when the furniture body is rotated. The tube merely rotates relative to the furniture body by the same angle that the furniture body is rotated. The objects deposited in the storage space tube are therefore not jumbled up despite the rotation of the furniture body. The tube can have separating elements in its longitudinal direction in order to make it possible to separate different storage compartments in the storage space tube and to prevent an undesired displacement of the deposited objects in the longitudinal direction of the tube. This can be of particular advantage, for example, when installing the multifunctional piece of furniture in a vehicle, wherein the longitudinal direction of the storage space tube points in a longitudinal direction of the vehicle. In this case, during acceleration processes of the vehicle, any displacement of the objects accommodated in the storage space is reliably prevented. The tube can be a tube extending over the entire length of the furniture body. It can also be shorter. Furthermore, several individual storage space tubes can also be arranged in the furniture body in order to create appropriate storage space.

According to a further advantageous embodiment of the invention, at least one additional weight is attached to an underside of the tube. By this means, the constant alignment of the tube in the event of a rotation of the furniture body can be further improved, for example when there are no objects in the storage space tube, so that the storage space opening providing access to the tube interior is always oriented ready for use in the provided usage position of the “storing” functional surface. Naturally, the storage space tube can also firstly be rotated by the user into a desired position for use. It is possible, for example, to use the functional surface with the intended use “storing” in different usage positions, that is to say different angular positions of the furniture body. For example, the storage space can be used in a first usage position, in which the functional surface with the intended use “storing” forms the upper side of the furniture body, or in other usage positions in which the functional surface with the intended use “storing” forms a front and/or rear side of the furniture body forms.

Accordingly, a further advantageous embodiment of the invention provides that the usage position assigned to the functional surface with the intended use “cooking” corresponds to the usage position assigned to the functional surface with the intended use “storing”. That is to say that both functional surfaces can be used at the same time. For example, the functional surface with the intended use “cooking” in this usage position forms a top side of the furniture body and the functional surface with the intended use “storing” forms a front side of the furniture body. The user can advantageously use the storage space that is accessible when cooking to store kitchen utensils and/or food.

Advantageously, according to yet another embodiment, the functional surface with the intended use “cooking” can provide the user with a sink with a fresh water supply and a service water disposal, wherein the service water disposal is configured and arranged to prevent service water from flowing back into the sink, that is, to reliably prevent service water already present in a drain pipe from flowing out during a subsequent rotation of the furniture body. For example, such a service water drain line can be guided and arranged helically along an imaginary helix within the furniture body in such a manner that a rotation of the furniture body in a predetermined direction of rotation always has the result that the service water in the drain line flow always from the sink. In this context, a restriction of the rotatability of the furniture body in merely a single predetermined direction of rotation is also advantageous, as has already been explained elsewhere herein, in order to prevent an accidental rotation in the opposite direction of rotation and thus further increase the usage comfort of the multifunctional furniture for the user.

In addition or as an alternative to the above twisting of a drain line, the service water disposal can have a non-return valve and/or a worm pump, which reliably prevents/prevent an uncontrolled backflow of service water from a drain line. For example, a serial arrangement of the non-return valve with a worm pump (Archimedean screw) arranged downstream can be provided.

According to a further aspect of the invention, in a method for using various functions of a multifunctional piece of furniture that serve different intended uses of a user, in particular a multifunctional piece of furniture according to one of the configurations disclosed herein, which has a furniture body with an outer surface, the outer surface is divided into at least two different functional surfaces serving the different intended uses of the user, wherein each functional surface is assigned at least one pre-determined usage position in which the respective functional surface can be used as intended according to its intended use by the user. Furthermore, an axis of rotation of the furniture body is defined by means of at least one suspension means, by means of which the furniture body is held rotatably about the axis of rotation in a spatially horizontal orientation at a furniture placement location at a distance therefrom, and the respective usage positions of the various functional surfaces can be reached by rotating the furniture body.

It should be pointed out that with regard to process-related definitions of terms and the effects and advantages of process-related features, reference can be made to and use can be made in full of the disclosures of corresponding definitions, effects and advantages in relation to the multifunctional furniture according to the invention disclosed herein. In other words, disclosures herein regarding the multifunctional piece of furniture according to the invention should also be able to be used analogously to define the method according to the invention, unless this is expressly excluded. Likewise, disclosures herein regarding the method according to the invention should be able to be used analogously to define the multifunctional furniture according to the invention, unless this is expressly excluded. In this respect, a repetition of explanations of the same features, their effects and advantages of the disclosed multifunctional furniture and the inventive method disclosed herein can fundamentally be dispensed with in favour of a concise description, without such omissions having to be interpreted as a restriction.

According to an advantageous further development of the invention, at least one supply line for power, gas and/or water is routed into the furniture body through a through-opening in the suspension means extending in the direction of the axis of rotation.

A further advantageous embodiment provides that the suspension means is rotatably or non-rotatably accommodated in at least one support, by means of which the suspension means is held in a fixed position at the furniture placement location and at the predetermined distance therefrom.

According to another advantageous embodiment of the invention, the rotation of the furniture body is selectively enabled or prevented by means of a fixing device, wherein the furniture body is fixed at least in the individual usage positions of the various functional surfaces by means of the fixing device.

In addition, in an advantageous further development of the invention, according to another embodiment, the rotation of the furniture body by means of the fixing device can always only be released in a predetermined direction of rotation.

According to a preferred further embodiment of the invention, the respective intended use of the functional surfaces is selected from the group containing working, cooking, storing, sleeping, wherein the user is provided with at least one flat work surface via the functional surface with the intended use “working”, the user is provided with at least one hotplate for heating food via the functional surface with the intended use “cooking”, the user is provided with at least one storage space for storing objects via the functional surface with the intended use “storing” and the user is provided with at least one lying surface via the functional surface with the intended use “sleeping”.

In an advantageous further development, the storage space within the furniture body can be formed by a tube running parallel to the axis of rotation and held rotatably on the furniture body.

At least one additional weight can optionally be attached to an underside of the tube, which intentionally creates an imbalance in relation to the rotation of the tube.

Furthermore, according to another advantageous embodiment of the invention, upon reaching the usage position assigned to the functional surface with the intended use “cooking”, the usage position assigned to the functional surface with the intended use “storing” is reached at the same time.

According to another preferred further development of the subject matter of the invention, the user is provided with a sink provided with a fresh water supply and a service water disposal via the functional surface with the intended use “cooking”, wherein a backflow of service water from the service water disposal into the sink is prevented by means of a non-return valve and/or a worm pump and/or a service water drain line guided helically along an imaginary helix.

According to a further aspect of the invention, a vehicle is disclosed, in particular a motor vehicle, which has a vehicle interior in which the multifunctional piece of furniture is functionally arranged.

The vehicle may be, for example, a user-habitable vehicle (i.e., having a habitable vehicle interior), such as a motor home, camper van, caravan, camping van, van, bus, coach, and the like.

According to a particularly preferred embodiment of the invention, the axis of rotation of the furniture body is aligned substantially parallel to a longitudinal axis of the vehicle. When the multifunctional piece of furniture is installed longitudinally, for example, the lying surface can be provided with a comfortable lying surface for the user which has a length in the range of preferably around 180 cm to 220 cm, but without being necessarily restricted to this.

Installing the multifunctional piece of furniture transversely in the vehicle, that is to say aligning the axis of rotation of the furniture body substantially parallel to a transverse axis of the vehicle, is also conceivable. For this purpose, for example, the lying surface can have lateral pull-out elements, so that when the functional surface with the intended use “sleeping” is not in use, sufficient space can be ensured at the side of the furniture body to the vehicle side walls and the lying surface can only be enlarged laterally for use by the pull-out elements to use the full width of the vehicle interior.

It should be noted that with regard to vehicle-related definitions of terms and the effects and advantages of vehicle-specific features, reference can be made to and use can be made of the disclosures of analogous definitions, effects and advantages in their full extent in relation to the multifunctional piece of furniture according to the invention disclosed herein. In other words, disclosures herein with regard to the multifunctional piece of furniture according to the invention can also be used analogously to define the vehicle according to the invention, unless this is expressly excluded. Likewise, disclosures herein regarding the vehicle according to the invention should be able to be used analogously to define the multifunctional furniture according to the invention, unless this is expressly excluded. In this respect, a repetition of explanations of analogously the same features, their effects and advantages of the disclosed multifunctional furniture according to the invention and the vehicle disclosed herein according to the invention can be dispensed with in favour of a concise description, without such omissions having to be interpreted as a restriction.

According to yet another aspect of the invention, a use of a multifunctional piece of furniture according to one of the configurations disclosed herein in a vehicle interior of a vehicle, in particular a motor vehicle, according to the configurations also disclosed herein is also disclosed.

The vehicle is particularly preferably a vehicle with a habitable vehicle interior, in which the multifunctional piece of furniture is functionally attached, for example a motor home, camper van, caravan, camping van, van, bus, coach, and the like

It should be mentioned again that with regard to use-related definitions of terms and the effects and advantages of use-related features, reference can be made in full to and use can be made of the disclosures of analogous definitions, effects and advantages in relation to the multifunctional piece of furniture disclosed herein. In other words, disclosures herein relating to the multifunctional piece of furniture according to the invention should also be able to be used analogously to define the use according to the invention, unless this is expressly excluded. Likewise, disclosures herein relating to the use according to the invention should be able to be used analogously to define the multifunctional piece of furniture according to the invention, unless this is expressly excluded. In this respect, a repetition of explanations of analogously the same features, their effects and advantages of the disclosed multifunctional piece of furniture according to the invention and the use according to the invention in a vehicle disclosed herein can be dispensed with in favour of a concise description without such omissions having to be interpreted as restricting.

Further features and advantages of the invention are obtained from the following description of exemplary embodiments of the invention, which are not to be understood as restrictive, which will be explained in more detail hereinafter with reference to the drawings. The drawings show schematically:

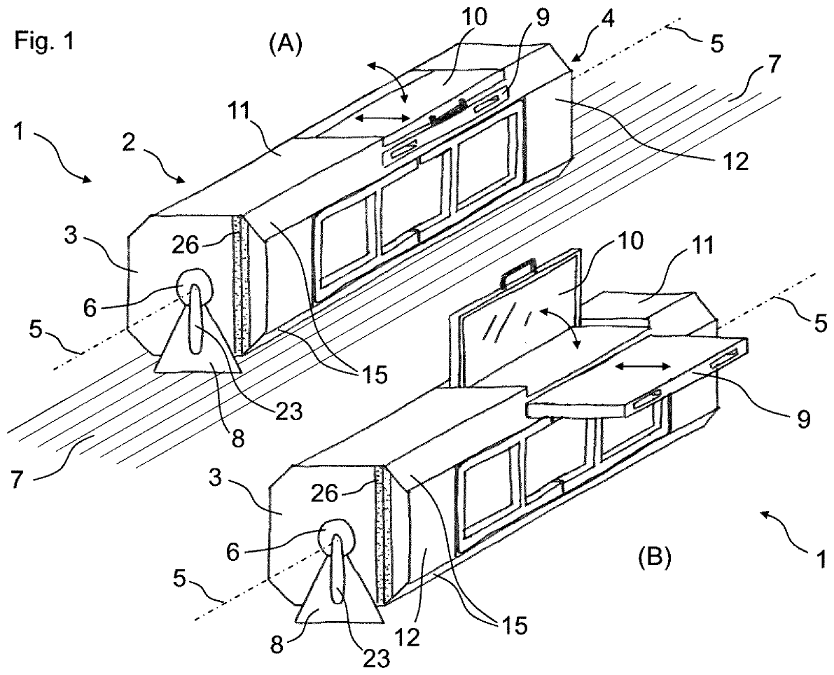

FIG. 1 shows in a perspective view A an embodiment of a multifunctional piece of furniture according to the invention with a first functional surface in its usage position in a non-used state and in a perspective view B, in a usage state,

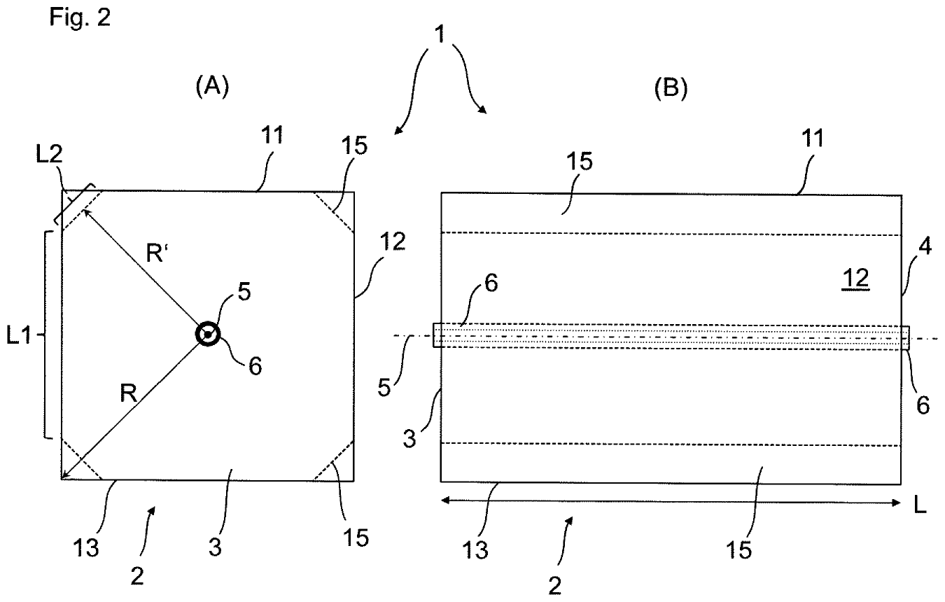

FIG. 2 shows in view A a cross-sectional view of the multifunctional piece of furniture from FIG. 1 and in view B a longitudinal side view of the multifunctional piece of furniture from view A,

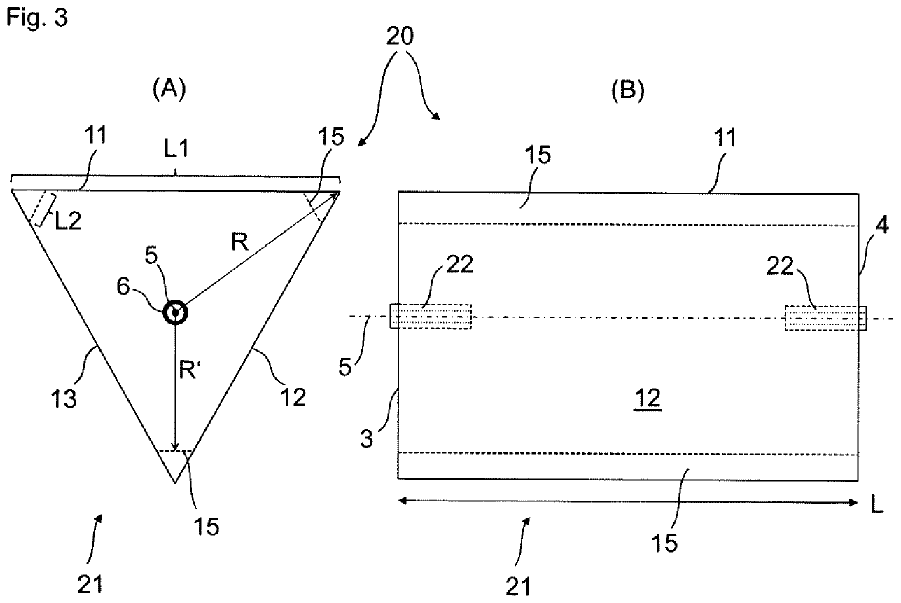

FIG. 3 shows in view A a cross-sectional view of a further embodiment of a multifunctional piece of furniture according to the invention and in view B a longitudinal side view of the multifunctional piece of furniture from view A,

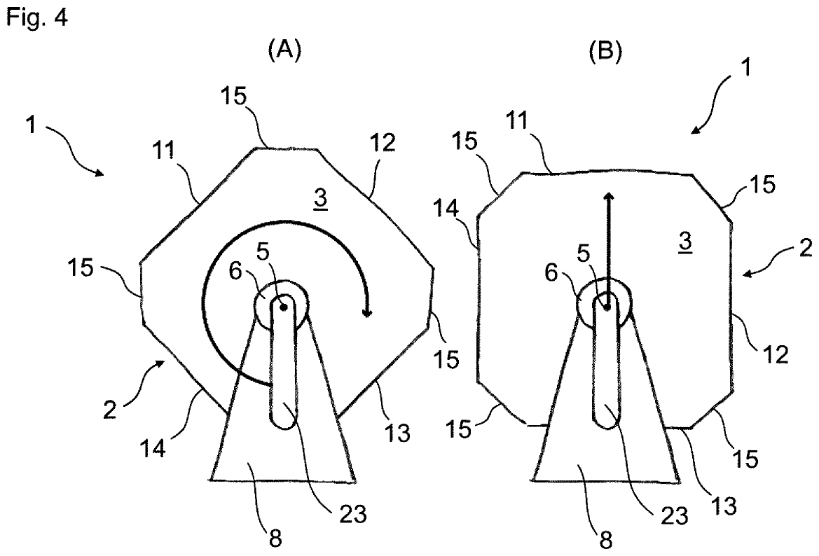

FIG. 4 shows in view A a plan view of an end face of the multifunctional piece of furniture from FIG. 1 during a rotational movement operated by an electric motor and in view B in a fixed usage position,

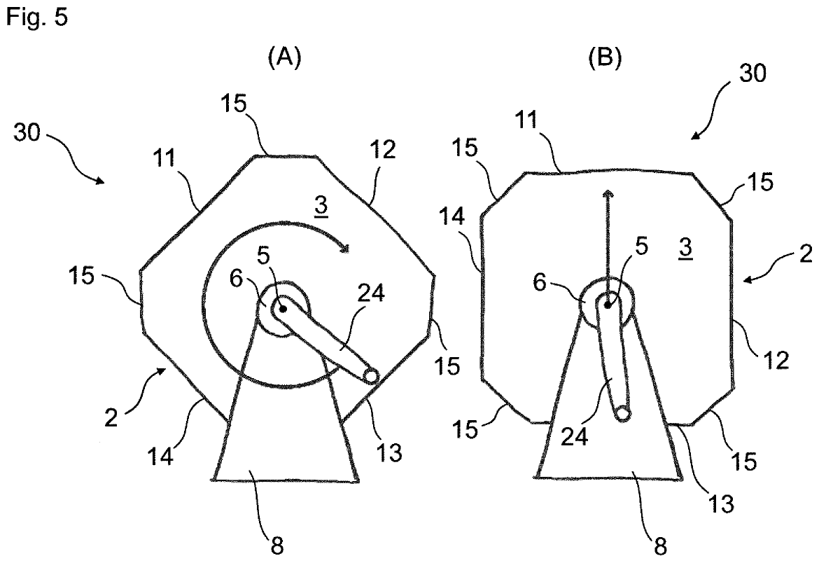

FIG. 5 shows in view A a plan view of an end face of yet another exemplary embodiment of a multifunctional piece of furniture according to the invention during a rotational movement operated by muscle power and in view B, in a fixed usage position,

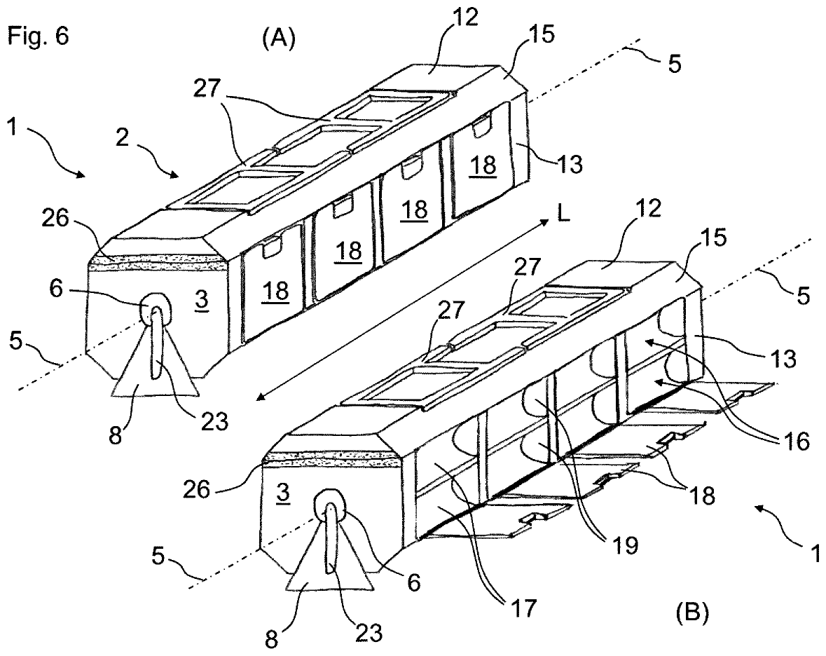

FIG. 6 shows a perspective view A of the multifunctional piece of furniture from FIG. 1 with a second and third functional surface in their usage positions in a non-used state and in a perspective view B, in a usage state of the third functional surface,

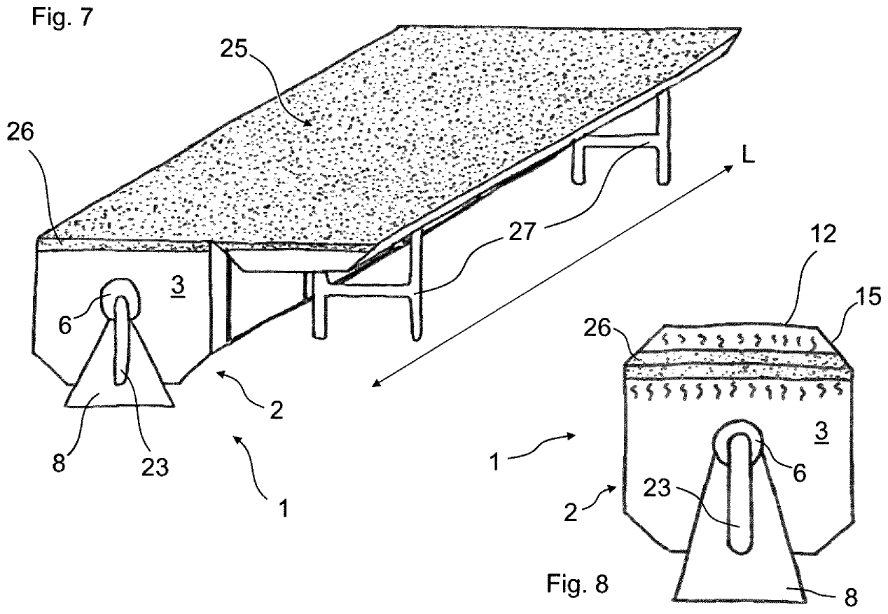

FIG. 7 shows a perspective view of the second functional surface from FIG. 6 in a first usage state,

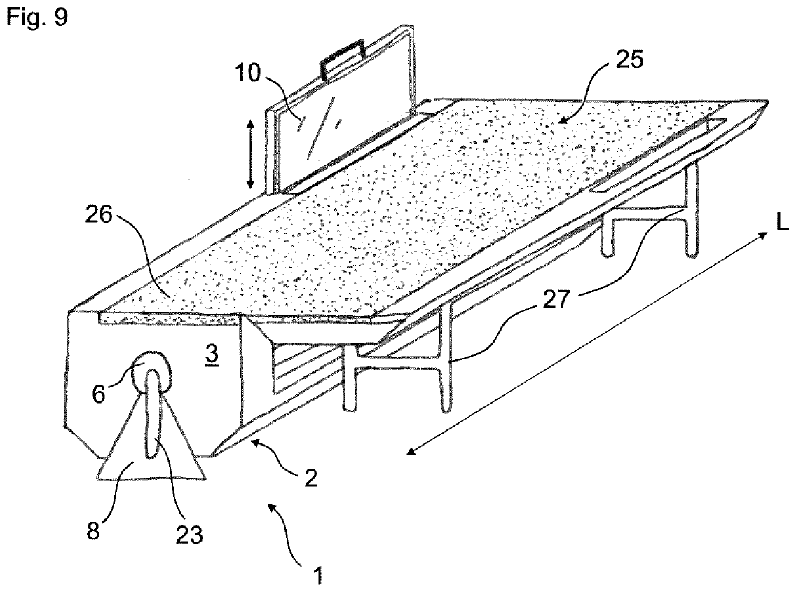

FIG. 8 shows a detailed plan view of the end face of the multifunctional piece of furniture from FIG. 7 with the second functional surface in a non-used state,

FIG. 9 shows a perspective view of the second functional surface from FIG. 7 in a second usage state,

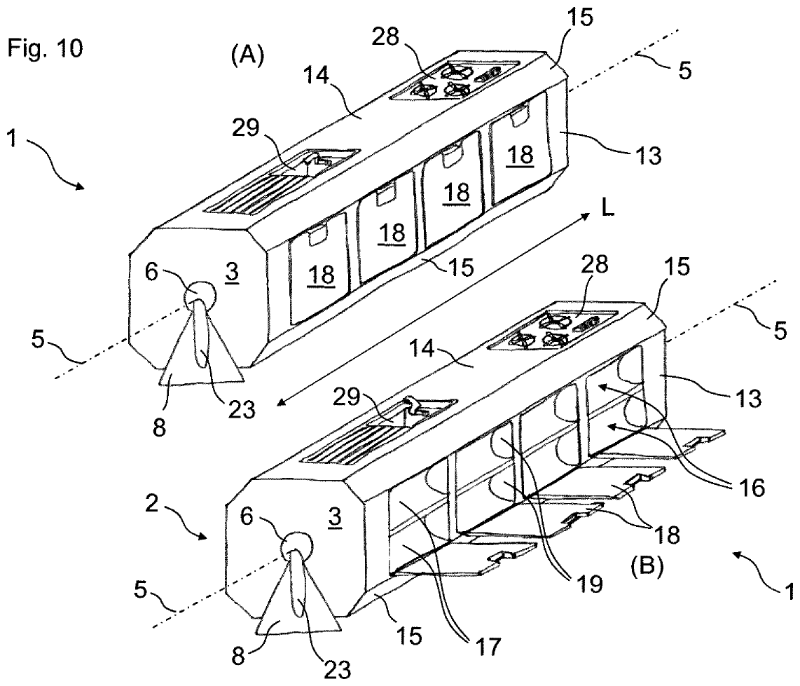

FIG. 10 shows in a perspective view A the multifunctional piece of furniture from FIG. 1 with the third and fourth functional surface in its usage positions in a non-usage state and in a perspective view B in a usage state of the third functional surface and

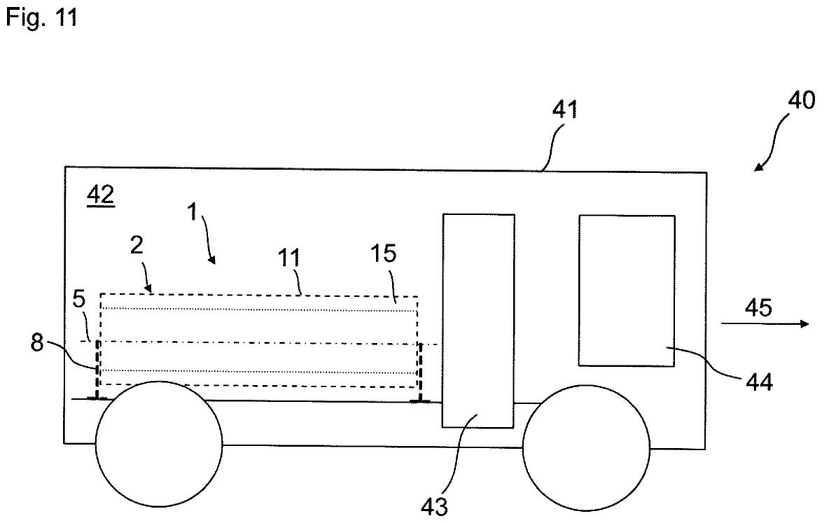

FIG. 11 shows an exemplary embodiment of a vehicle according to the invention and an exemplary embodiment for the inventive use of an example of a multifunctional piece of furniture according to the invention in a vehicle.

In the different figures, equivalent parts in terms of their function are always provided with the same reference numbers so that they are usually only described once.

FIG. 1 shows in a perspective view A an exemplary embodiment of a multifunctional piece of furniture 1 according to the invention with a first functional surface 11 in its usage position in a non-used state and in a perspective view B, the functional surface 2 in a usage state.

The multifunctional piece of furniture 1 has a furniture body 2 which has an substantially closed outer surface. In the exemplary embodiment shown, the furniture body 2 is substantially in the form of a prism having a base surface 3, an opposite top surface 4 and with a lateral surface connecting the base surface 2 with the top surface 3, which forms the outer surface of the furniture body. In the example shown, the base surface 3 corresponds to a first end face of the furniture body 2, and the top surface 4 corresponds to a second end face (not visible in FIG. 1) of the furniture body 2.

The outer surface or in the present case, the lateral surface of the furniture body 2 shown is divided into a total of four different functional surfaces 11, 12, 13, 14 serving different intended uses of a user not shown, two of which can be seen in FIG. 1.

In the present case, the functional surface 11 is assigned the intended use “working”, the functional surface 12 is assigned the intended use “sleeping”, the functional surface 13 is assigned the intended use “storing” and the functional surface 14 is assigned the intended use “cooking”, as will be described in more detail hereinafter. In addition, each functional surface 11, 12, 13, 14 is assigned at least one predetermined usage position, in which the respective functional surface 11, 12, 13 or 14 can be used by the user as intended according to its intended use. In FIG. 1 the functional surface 11 presently forming the top side of the furniture body is shown in its usage position.

As can also be deduced from FIG. 1, the furniture body 2 has a suspension means 6 that defines an axis of rotation 5, which in the present case is configured as a shaft running between the two opposite end faces 3 and 4 of the furniture body 2, but without necessarily being restricted to this. In any case, the suspension means 6 is adapted to hold the furniture body 2 rotatably about the axis of rotation 5 at a furniture placement location 7, which is illustrated by way of example in FIG. 1 as a floor surface but without necessarily being restricted to this (for example, the placement location can also be formed by walls, a ceiling and the like) at a distance from the placement location or from the floor surface 7.

It can be deduced from FIG. 1 that the axis of rotation 5 is kept horizontally aligned in space at the placement location 7. As has already been mentioned elsewhere herein, the alignment of the axis of rotation 5 at the placement location of the furniture body 2 is always aligned horizontally for the intended and functional use of the multifunctional furniture 1. It should therefore be understood that even when the furniture body is held on or between two walls (not shown) running substantially perpendicularly to the floor surface 7, the spatial alignment of the axis of rotation 5 at the placement location is still fixed horizontally.

In the embodiment shown in FIG. 1 the multifunctional item of furniture 1 can additionally have two supports 8 (e.g. trestles, legs, tripods, etc., which can be set up or fastened at the placement location 7), of which only the front support 8 arranged on the first end face 3 can be seen in FIG. 1. However, it should be understood that such a support 8 is also provided in the same way on the second end face 4 of the furniture body 2. The supports 8 are configured to accommodate the suspension means 6, in this case the shaft, in a rotatable or non-rotatable manner and to hold it in a fixed position at the furniture placement location 7 and at the predetermined distance therefrom. In the exemplary embodiment of the multifunctional piece of furniture 1 shown here, the furniture body 2 is connected non-rotatably to the shaft 6 so that the supports 8 each receive and hold the shaft 6 in a rotatable manner in this case. It is also conceivable that the shaft 6 supports the furniture body 2 in a rotatable manner so that the shaft 6 can be accommodated non-rotatably in the supports 8. In the case of the multifunctional piece of furniture 1 shown here, the shaft 6 is also configured as a hollow shaft, but is not necessarily restricted to this.

The rotatability of the furniture body 2 at the placement location 7 enables the respective usage positions of the various functional surfaces 11, 12, 13, 14 to be reached by rotating the furniture body 2. As already mentioned, the functional surface 11 in FIG. 1 is located in its top-side usage position. The intended use “working” of the functional surface 11 provides the user with a flat work surface 11, for example in the manner of a free table surface. In the case of the multifunctional piece of furniture 1 shown in FIG. 1, a part of the work surface is additionally provided as a table surface 9 that can be pulled out from the furniture body 2 (see arrow). View A shows the table surface 9 in a position inserted into the furniture body 2, view B shows it in the extended position. In addition, the functional surface 11 in the present case also has a screen or monitor 10 that can also be pivoted out (see arrow) and/or pulled out (see also arrow) of the furniture body 2 without necessarily being restricted to this. In view A, the screen 10 is shown in its pivoted-in position, in view B in the pivoted-out position. The screen 10 can be configured to display different content. For example, the screen 10 can be a TV screen and/or a computer monitor that can be connected to a computer not shown. To this end, the screen can provide 10 different connection options (not shown), for example connections such as HDMI/HDMI mini, DisplayPort/DisplayPort mini, USB, network, etc. These can, for example, be arranged and provided on one of the end faces 3 or 4 and guided accordingly through the interior of the furniture body 2 to the screen 10. Attachment of the connections to the end faces 3 and/or 4 enables them to be used even when the screen 10 is folded or retracted (e.g. to provide a charging function via a USB connection). Alternatively or additionally, the connections can also be arranged at the edge of the screen and/or on a rear wall of the screen, so that they are only accessible when the screen is pulled out or opened and are otherwise protected by the furniture body 2.

It can further be identified in FIG. 1 that the base surface 3 (and likewise the non-visible top surface 4) of the furniture body 2, which is configured to be prismatic in the present case, are also configured in the form of a polygon with eight corners each.

In view A, FIG. 2 shows a cross-sectional view of the multifunctional piece of furniture 1 from FIG. 1 and in view B a longitudinal side view of the multifunctional piece of furniture 1 from view A. It can be seen that the octagonal polygon (comprising the dashed lines) has four equal-length sides of a first length L1 and four equal-length sides of a second length L2, the second length L2 being significantly shorter than the first length L1.

The first, longer length L1 of the base-surface and top-surface polygon, together with the length L of the furniture body 2, determines the usable area of the respective functional surface 11, 12, 13, 14. The second, shorter length L2 of the base-surface and top-surface polygon substantially provides a bevelled transition 15 from one functional surface to the next functional surface. Due to the bevel 15, the usable area of the functional surfaces 11, 12, 13, 14 is slightly reduced compared to an embodiment with directly adjacent functional surfaces without a bevelled intermediate surface 15 (cf. solid lines in FIG. 2, which represent the base-surface polygon with only four corners) but advantageously also the maximum radius R, R′ or corresponding diameter to be taken into account for the rotation of the furniture body 2. The furniture body 2 with bevelled intermediate surfaces 15 is more compact and requires a smaller volume at the placement location 7. In addition, tapered abutting edges of adjacent functional surfaces 11, 12, 13, 14 without intermediate surfaces 15 are avoided in the furniture body 2 according to the configuration with intermediate surfaces 15.

View B of FIG. 2 also shows the shaft 6 configured as a hollow shaft in the present multifunctional piece of furniture 1, which extends through the furniture body 2 from the first end face 3 to the second end face 4.

In view A, FIG. 3 shows a cross-sectional view of a further exemplary embodiment of a multifunctional piece of furniture 20 with a furniture body 21 according to the invention, and in view B a longitudinal side view of the multifunctional piece of furniture 20 from view A.

A significant difference compared to the multifunctional piece of furniture 1 from FIGS. 1, 2 is that the furniture body 21 of the multifunctional piece of furniture 20 shown in FIG. 3 has only three different functional surfaces, for example the functional surfaces 11, 12, 13. The base surface 3 and top surface 4 of the likewise prismatic furniture body 21 have a polygonal surface each with three (continuous line) or six corners (comprising the dashed lines). In the case of the hexagonal polygon, four equal-length sides having a first length L1 and four equal-length sides having a second length L2 are again provided, with the second length L2 being significantly shorter than the first length L1.

In the exemplary embodiment shown in FIG. 3, the first, longer length L1 of the base-surface and top-surface polygon, together with the length L of the furniture body 21, determines the usable area of the respective functional surface 11, 12, 13. The second, shorter length L2 of the base-surface and top-surface polygon provides the bevelled transition 15 from one functional surface to the next functional surface. Due to the bevel 15, the usable area of the functional surfaces 11, 12, 13 is slightly reduced compared to an embodiment with directly adjacent functional surfaces without a bevelled intermediate surface 15 (cf. solid lines in FIG. 3, which represent the base-surface polygon with only three corners), but advantageously also the maximum radius R, R′ or corresponding diameter to be taken into account for the rotation of the furniture body 21. The furniture body 21 with bevelled intermediate surfaces 15 is therefore more compact and requires a smaller volume at the placement location 7. In addition, tapered abutting edges of adjoining functional surfaces 11, 12, 13 without intermediate surfaces 15 are avoided in the case of the furniture body 21 with intermediate surfaces 15.

Another difference from the furniture body 2 of FIG. 2 is the configuration of the suspension means 6. In the case of the furniture body 21, two suspension means 22 (one on each end face 3, 4) in the form of respective shaft pieces are provided. In the present case, the shaft pieces 22 are also each configured as hollow shafts without necessarily being restricted to this. Both shaft pieces 22 can be configured as solid shafts. One of the two shaft pieces can also be configured as a hollow shaft and the other as a solid shaft.

Both the shaft 6 or hollow shaft of the multifunctional piece of furniture 1 from FIGS. 1 and 2 as well as the shaft pieces 22 or hollow shaft pieces of the multifunctional piece of furniture 20 from FIG. 3, which are configured with an inner passage, are adapted for conducting at least one supply line (not shown) for power, gas and/or water into the furniture body 2 or 21.

In view A, FIG. 4 shows a plan view of the end face 3 of the multifunctional piece of furniture 1 from FIG. 1 during a rotational movement (shown by an arrow) operated by an electric motor and in view B, in a fixed usage position. For the electric motor drive, the multifunctional piece of furniture 1 has an electric motor 23 which acts on the suspension means 6 or, in the present case, on the shaft 6 and which is fastened to the support 8 as a counter-bearing. In addition, the multifunctional piece of furniture 1 has a fixing device (not shown), which optionally enables or prevents the rotation of the furniture body 2, wherein the furniture body 2 can be fixed at least in the usage positions of the various functional surfaces 11, 12, 13, 14 by means of the fixing device (cf. view B) to enable the user to use them comfortably and securely.

FIG. 5 shows an alternative drive option for rotating a furniture body 2 of yet another embodiment of a multifunctional piece of furniture 30 according to the invention. In particular, FIG. 5 shows, in view A, a plan view of an end face 3 of the multifunctional piece of furniture 30 during a rotational movement driven by muscle power (arrow) and in view B in a fixed usage position. For this purpose, a hand crank 24 is provided instead of the electric motor 23 of the multifunctional piece of furniture 1 shown in FIG. 4, which transmits a torque introduced by the user on the hand crank 24 to a suspension means 6, which in the present case can be configured as a (possibly hollow) shaft 6. The multifunctional piece of furniture 30 also has a fixing device (not shown), which optionally enables or prevents the rotation of the furniture body 2, wherein the furniture body 2 can be fixed at least in the usage positions of the various functional surfaces 11, 12, 13, 14 by means of the fixing device (cf. view B) to enable the user to use them comfortably and securely.

FIG. 6 shows in a perspective view A the multifunctional piece of furniture 1 from FIG. 1 with the second and third functional surface 12 and 13 in their usage positions in a non-used state and in a perspective view B, in a usage state of the third functional surface 13.

The functional surface 13 with the intended use “storing” provides the user with at least one storage space 16 for storing objects (not shown), as can be seen in view B. The storage space 16 is formed in the present case by two tubes 17 running parallel to the axis of rotation 5 and held rotatably on the furniture body 2. However, this is not necessary. The storage space can also be provided by conventional, immovable compartments.

In the present exemplary embodiment, the storage space tubes 17 extend over the entire length L of the furniture body 2, without necessarily being restricted thereto. The storage space 16 is accessible via corresponding storage space openings in the respective tubes 17. The storage space 16 can also be closed on the outer surface of the furniture body 2 by means of pivotable doors 18 (four in the present case). In addition, the storage space tubes 17 are divided by partitions 19 into several storage compartments in their longitudinal direction according to each pivoting door.

The tubes 17 can have additional weights (not shown) on their undersides to stabilize their alignment during a rotation of the furniture body 2. However, this is not necessary.

As already mentioned, the intended use “sleeping” is assigned to the functional surface 12. The functional surface 12 provides the user with a lying surface 25, as can be clearly seen in FIG. 7 in a (folded out) usage state. In FIG. 6A the lying surface 25 can be seen in a folded-in state. The lying surface 25 is covered with a lying pad 26, e.g. a mattress.

FIG. 7 shows a perspective view of the second functional surface 12 from FIG. 6 in a first usage state. It can be seen that the part of the lying surface 25 folded out over the furniture body 2 is supported at the placement location 7 by means of foldable support legs 27. In FIG. 6, the support legs 27 are folded in alignment with the outer surface of the furniture body 2 in their unused position in a space-saving manner.

In order to achieve the usage state shown in FIG. 7 with sole use of the lying surface 25, the support legs 27 are initially unlocked, for example, in the position of the furniture body 2 shown in FIG. 6A. It is to be understood that the support legs 27 in their non-use position in the position shown in FIG. 6A are secured on the furniture body 2 by means of a corresponding support leg lock (not shown).

For an additional increase in placement safety, metal contact surfaces (not shown) for the respective support legs 27 can be provided at the placement location or the floor surface 7, on which the support legs 27 rest in their unfolded position with their free, floor-side ends and can optionally be brought into engagement. The engagement can be produced positively (e.g. locking) or only non-positively, for example via a magnetic force, clamping force and the like. In any case, accidental folding over of the support legs 27 during usage of the lying surface 25 can be reliably prevented.

The lying surface 25 can be unfolded after unlocking the support legs 27, for example whereby two handles (not shown) recessed into corresponding recesses, e.g. expander handles, can be pulled by the user to pivot out the lying surface 25 to open it, starting from the folded-in position shown in FIG. 6A. The support legs 27 can be configured and arranged to swing out automatically at an opening angle of about 100° of the lying surface 25 in order to engage with the floor-side metal contact surfaces at an opening angle of about 178° of the lying surface 25.

After reaching the fully unfolded state of the lying surface 25 shown in FIG. 7, retaining straps (not shown) that hold the mattress 26 can be released. The mattress 26 can preferably be fixed on its underside on the furniture body 2 by means of hook and loop fasteners in order to prevent any slipping. Preferably, the hook and loop fastener function can be provided by a cover encasing the mattress 26. Furthermore, a slatted frame (not shown) can be arranged between the mattress 26 in order to ensure ventilation of the mattress 26. Pillows and bed covers (both not shown) can also be equipped with a hook and loop fastener holding function and be held/attached accordingly to the furniture body 2.

The lying surface 25 shown in FIG. 7 can have a size of 160 cm (or 180 cm)×200 cm, for example.

FIG. 8 shows a detailed plan view of the end face 3 of the multifunctional piece of furniture 1 from FIG. 7 with the second functional surface 12 in the unused state. In FIG. 8 it is also shown that the lying surface 25 or the pad 26 can be heated in the present exemplary embodiment, but without being necessarily restricted to this. The heatability of the lying surface 25 or lying pad 26 offers a significant advantage when using the multifunctional piece of furniture 1 in a habitable vehicle at low ambient temperatures, for example in winter.

FIG. 9 shows a perspective view of the second functional surface 12 from FIG. 7 in a second usage state. It can be seen that the lying surface 25 can advantageously be used at the same time as the screen 10 (e.g. TV/computer screen) assigned to the first functional surface 11. To do this, the screen 10 can be pulled out of the functional surface 11 (see arrow in FIG. 1A) instead of being pivoted out (see 1B). In this way, a simultaneous use of the first functional surface 11 and the second functional surface 12 can be achieved. As already mentioned, in the pulled-out position of the screen 10, the connection options it provides, such as HDM, DisplayPort, USB and the like, can also be used in the lying function.

FIG. 10 shows in a perspective view A the multifunctional piece of furniture 1 from FIG. 1 with the third and fourth functional surfaces 13, 14 in their usage positions in a non-used state and in a perspective view B, in a usage state of the third functional surface 13. The usage position assigned to the functional surface 14 with the intended use “cooking” thus corresponds to the usage position assigned to the functional surface 13 with the intended use “storing”, since both intended uses can be used simultaneously in one and the same angular position of the furniture body 2.

It can be seen from FIG. 10 that the functional surface 14 provides the user with a hotplate 28 for heating food. In the present case, the hotplate 28 is configured as a gas stove. An electric stove is also conceivable. In addition, in the exemplary embodiment shown, the functional surface 14 provides a sink 29 with a fresh water supply (not shown) and a service water disposal (also not shown). The service water disposal is configured and arranged to prevent any backflow of service water into the sink 29, in particular during a rotation of the furniture body 2. For this purpose, the service water disposal can have, for example, a non-return valve and/or a worm pump (neither of which is shown). In particular, it can also be advantageous in this context to design the fixing device (not shown) in such a manner that the rotation of the furniture body 2 is always only possible in a single predetermined direction of rotation.

FIG. 11 shows an exemplary embodiment of a vehicle 40 according to the invention and an exemplary embodiment for the inventive use of an example of a multifunctional piece of furniture, e.g. the multifunctional furniture 1 or 20, according to the invention in a vehicle, here the vehicle 40. The vehicle 40 has an interior space 42 formed by a vehicle structure 41, in particular a vehicle interior space that can be inhabited by a user (not shown). In the vehicle interior 42, the multifunctional piece of furniture 1 is functionally set up or attached/fastened. The interior 42 can be reached, for example, via an entrance door 43 provided specifically for this purpose, but without being necessarily restricted to this. The vehicle interior 42 can also be reached via the driver's or passenger door 44 if the driver's cab of the vehicle 40 is continuously connected to the vehicle interior 42.

In FIG. 11, the multifunctional piece of furniture 1 shown in FIG. 1 is set up in the vehicle interior 42 with its axis of rotation 5 parallel to the longitudinal axis 45 of the vehicle (accordingly also horizontally in space). A transverse placement of the multifunctional piece of furniture 1 in the vehicle interior 42 is fundamentally also possible.

In the present case, the vehicle 40 is, for example, a a motor home such as a camper van, camping van and the like. Other types of vehicles including rail vehicles, aeroplanes, boats, ships and the like are also conceivable.

The multifunctional piece of furniture according to the invention disclosed herein and the vehicle according to the invention and the use of the same in a vehicle disclosed herein are not restricted to the embodiments described in each case, but also include other embodiments which act in the same way and which result from other technically meaningful further combinations of the features of the functional piece of furniture described here as well as from its use. In particular, the features and feature combinations mentioned hereinbefore in the general description and the description of the figures and/or shown alone in the figures can be used not only in the combinations explicitly stated herein, but also in other combinations or on their own, without going beyond the scope of the present invention.

In a particularly preferred embodiment, the multifunctional piece of furniture according to the invention is used in a vehicle interior of a vehicle that can be inhabited by a user, preferably a motor vehicle such as a motor home, camper van, caravan, camping van, van, bus, coach, and the like. However, the invention is not necessarily restricted to such land vehicles but can also be used, for example, in rail-bound land vehicles (e.g. trains), aircraft (e.g. aeroplanes) and watercraft (e.g. boats, ships). Even a use of the multifunctional furniture in stationary facilities such as buildings, e.g. hotels, apartments and the like, is conceivable.

When using the multifunctional piece of furniture in a vehicle, the axis of rotation of the furniture body is preferably aligned parallel to a longitudinal axis of the vehicle. This enables, among other things, the provision and use of a lying surface that can be used by a user, which preferably has a length in the range from about 190 cm to 220 cm and a width in the range from about 80 cm to 120 cm.

### REFERENCE LIST

1 Multifunctional furniture
2 Furniture body
3 Base surface/first end face
4 Top surface/second end face
5 Axis of rotation
6 Suspension means
7 Furniture placement location/floor surface
8 Support
9 Pull-out table surface
10 Screen
11 First functional surface, intended use “working”, work surface
12 Second functional surface, intended use “sleeping”
13 Third functional surface, intended use “storing”
14 Fourth functional surface, intended use “cooking”
15 Bevelled transition/intermediate surface
16 Storage space
17 Rotatable tube
18 Pivoting door
19 Partition
20 Multifunctional furniture
21 Furniture body
22 Suspension means
23 Electric motor
24 Hand crank
25 Lying surface
26 Pad
27 Support leg
28 Hotplate
29 Sink
30 Multifunctional furniture
40 Vehicle
41 Vehicle structure
42 Vehicle interior
43 Entrance door
44 Driver/passenger door
Vehicle longitudinal axis
L Body length
LI First length
L2 Second length
R Maximum radius without bevelled intermediate surface
R′ Maximum radius with bevelled intermediate surface

1-57. (canceled)

58. Multifunctional furniture (1, 20, 30), in particular for installation in a vehicle (40), for providing various functions serving different purposes of use of a user, having a furniture body (2, 21) with an outer surface, the outer surface being divided into at least four different functional surfaces (11, 12, 13, 14) serving the different purposes of use of the user, wherein each functional surface (11, 12, 13, 14) is divided into at least two functional surfaces (11, 12, 13, 14), wherein each functional surface (11, 12, 13, 14) is divided into at least two functional surfaces (11, 12, 13, 14), at least one predetermined position of use is assigned to the functional surface (11, 12, 13, 14), in which the respective functional surface (11, 12, 13, 14) can be used by the user in accordance with its purpose of use, and at least one suspension means (6, 22) is provided, which is constructed and arranged in such a way that the functional surface (11, 12, 13, 14) can be used by the user in accordance with its purpose of use a rotational axis (5) of the furniture carcass (2, 21) and to hold the furniture carcass (2, 21) at a furniture support location (7) at a distance therefrom so as to be rotatable about the rotational axis (5) in a spatially horizontal alignment, the respective positions of use of the various functional surfaces (11, 12, 13, 14) being achievable by rotating the furniture carcass (2, 21), characterized in that the respective intended use of the functional surfaces (11, 12, 13, 14) is selected from the group comprising working, cooking, storing, sleeping, wherein the functional surface (11) with the intended use “working” provides the user with at least one flat working surface (9), the functional surface (14) with the intended use “cooking” provides the user with at least one cooking area (28) for heating foodstuffs, the functional surface (13) with the intended use “stowing” provides the user with at least one storage space (16) for storing objects, and the functional surface (12) with the intended use “sleeping” provides the user with at least one lying surface (25), the position of use assigned to the functional surface (14) with the intended use “cooking” corresponding to the position of use assigned to the functional surface (13) with the intended use “stowing”.

59. Multifunctional furniture (1, 20, 30) according to claim 58, characterized in that the furniture body (1, 20, 30) is formed substantially in the form of a prism with a base surface (3), an opposite cover surface (4) and with a jacket surface connecting the base surface (3) to the cover surface (4), the jacket surface forming the outer surface of the furniture body (2, 21) divided into the various functional surfaces (11, 12, 13, 14).

60. Multifunctional furniture (1, 20, 30) according to claim 59, characterized in that the base surface (3) and the top surface (4) of the prismatically formed furniture body (2, 21) are formed in the shape of a polygon with three or four corners each.

61. Multifunctional furniture (1, 20, 30) according to claim 60, characterized in that the base surface (3) and the top surface (4) of the prismatically formed furniture body (2, 21) are formed in the shape of a polygon with six corners or eight corners in each case, the hexagonal and the octagonal polygon having in each case three or four sides of equal length of a first length (L1) and three or four sides of equal length of a second length (L2) smaller than the first length (L1).

62. Multifunctional furniture (1, 20, 30) according to claim 58, characterized in that the suspension means (6, 22) has a passage opening in the direction of the axis of rotation (5), which is directed into the body (2, 21) for the passage of at least one supply line for electricity, gas and/or water.

63. Multifunctional furniture (1, 20, 30) according to claim 58, characterized in that the suspension means (6, 22) as shaft pieces provided on two opposite end faces (3, 4) of the furniture body (2, 21), respectively, or as a shaft is formed extending between the two opposite end faces (3, 4) of the furniture body (2, 21).

64. Multifunctional furniture (1, 20, 30) according to claim 63, characterized in that the furniture body (2, 21) is non-rotatably connected to the shaft pieces or the shaft (6).

65. Multifunctional furniture (1, 20, 30) according to claim 63, characterized in that at least one of the shaft sections (22), preferably both shaft sections, or the shaft (6) is/are formed hollow at least on the input and/or output side.

66. Multifunctional furniture (1, 20, 30) according to claim 58, characterized in that at least one holding support (8) is provided which is designed and arranged to receive the suspension means (6, 22) in a rotatable or non-rotatable manner and to hold it at the furniture installation location (7) in a stationary manner and at the predetermined distance therefrom.

67. Multifunctional furniture (1, 20, 30) according to claim 58, characterized in that a fixing device is provided which selectively releases or prevents the rotation of the furniture body (2, 21), wherein the furniture body (2, 21) can be fixed by means of the fixing device at least in the individual positions of use of the various functional surfaces (11, 12, 13, 14).

68. Multifunctional device (1, 20, 30) according to claim 67, characterized in that the fixing device always releases the rotation of the furniture carcass (2, 21) only in a predetermined direction of rotation.

69. Multifunctional furniture (1, 20, 30) according to claim 58, characterized in that the storage space (16) within the furniture carcass (2, 21) is formed by a tube (17) extending parallel to the axis of rotation (5) and held rotatably on the furniture carcass (2, 21).

70. Multifunctional furniture (1, 20, 30) according to claim 69, characterized in that at least one additional weight is attached to an underside of the tube (17).

71. Multifunctional furniture (1, 20, 30) according to claim 58, characterized in that the functional surface (1, 20, 30) with the intended use “cooking” provides the user with a sink (29) with a fresh water supply and a service water disposal, wherein the service water disposal is designed and arranged to prevent a backflow of service water into the sink (29).

72. Multifunctional furniture (1, 20, 30) according to claim 71, characterized in that the service water disposal system has a backwater flap and/or a screw pump and/or a service water discharge pipe guided in a helical manner along an imaginary screw line.

73. Method for using different functions, serving different purposes of use of a user, of a multifunctional piece of furniture (1, 20, 30), in particular according to one of the preceding claims, which has a furniture body (2, 21) with an outer surface, the outer surface being divided into at least four different functional surfaces (11, 12, 13, 14) serving the different purposes of use of the user, wherein each functional surface (11, 12, 13, 14) is assigned at least one predetermined position of use in which the respective functional surface (11, 12, 13, 14) is operated by the user in accordance with its intended use, and an axis of rotation (5) of the furniture body (2, 21) is fixed by means of at least one suspension means (6, 22), by means of which the furniture body (2, 21) is held rotatably about the axis of rotation (5) in a spatially horizontal orientation at a plank mounting point (7) at a distance therefrom, and the respective usage positions of the various functional surfaces (11, 12, 13, 14) are adjusted by rotating the furniture body (2, 21), characterized in that the respective intended use of the functional surfaces (11, 12, 13, 14) is selected from the group comprising working, cooking, stowing, sleeping, at least one flat work surface (9) being provided for the user via the functional surface (11) with the intended use “working”, the user being provided with at least one flat work surface (9) via the functional surface (14) with the intended use, “Cooking” at least one cooking area (28) for heating food is provided, at least one storage space (16) for storing objects is provided to the user via the functional area (13) with the purpose of use “Stowing” and at least one lying area (25) is provided to the user via the functional area (12) with the purpose of use “Sleeping”, wherein upon reaching the functional area (13) with the purpose of use “Stowing” at least one lying area (25) is provided to the user, wherein upon reaching the functional area (12) with the purpose of use “Sleeping” at least one lying area (25) is provided to the user (14) with the intended use “cooking” is reached at the same time as the position of use assigned to the functional surface (13) with the intended use “stowing”.

74. Method according to claim 73, characterized in that at least one supply line for electricity, gas and/or water is guided into the furniture body (2, 21) through a passage opening in the suspension means (6, 22) extending in the direction of the axis of rotation (5).

75. Method according to claim 73, characterized in that the suspension means (6, 22) is received rotatably or non-rotatably in at least one holding support (8), by means of which the suspension means (6, 22) is held stationary at the furniture installation location (7) and at the predetermined distance therefrom.

76. Method according to claim 73, characterized in that the rotation of the furniture carcass (2, 21) is selectively released or prevented by means of a fixing device, the furniture carcass (2, 21) being fixed by means of the fixing device at least in the individual positions of use of the various functional surfaces (11, 12, 13, 14).

77. Method according to claim 76, characterized in that the rotation of the furniture carcass (2, 21) by means of the fixing device is always released only in a predetermined direction of rotation.

78. A method according to claim 73, characterized in that the storage space (16) within the furniture body (2, 21) is formed by a tube (17) extending parallel to the axis of rotation (5) and rotatably held on the furniture body (2, 21).

79. Method according to claim 78, characterized in that at least one additional weight is attached to an underside of the tube (17).

80. Method according to claim 73, characterized in that the user via the functional surface (1, 20, 30) with the purpose of use A sink (29) with a fresh water supply and a service water disposal system is provided for “cooking”, wherein a backflow of service water from the service water disposal system into the sink (29) is prevented by means of a backflow flap and/or a worm pump and/or a service water drainage line guided helically along an imaginary helix.

81. Vehicle (40), in particular motor vehicle, having a vehicle interior (42) has, characterized in that a multifunctional furniture unit (1, 20, 30) according to claim 58 is operatively arranged in the vehicle interior (42).

82. Vehicle (40) according to claim 81, characterized in that the axis of rotation (5) of the furniture body (1, 20, 30) is parallel to a longitudinal axis (45) of the vehicle (40) is aligned.

83. Vehicle (40) according to claim 81, characterized in that the vehicle (40) is a vehicle that can be inhabited by a user, in particular a motor home, caravan, camping van, transporter, bus.

84. Use of a multifunctional piece of furniture (1, 20, 30) in accordance with one of the an The system is designed to be used in a vehicle interior (42) of a vehicle (40), in particular a motor vehicle, in accordance with claim 81.
